(19) United States
(12) Patent Application Publication
(10) Pub. No.: US 2011/0293885 A1
(43) Pub. Date: Dec. 1, 2011

(54) BAMBOO ARTIFICIAL BOARD UNIT, MANUFACTURING METHOD THEREOF AND APPARATUS THEREFOR

(76) Inventors: Wenji Yu, Beijing (CN); Yanglun Yu, Beijing (CN); Zhiying Su, Beijing (CN); Yue Zhou, Beijing (CN); Rongxian Zhu, Beijing (CN); Dinghua Ren, Beijing (CN)

(21) Appl. No.: 13/201,223

(22) PCT Filed: Feb. 11, 2010
(86) PCT No.: PCT/CN2010/070663

§ 371 Date: Aug. 12, 2011

(30) Foreign Application Priority Data
Feb. 13, 2009 (CN) 200920105912X
Feb. 13, 2009 (CN) 2009201059149
Feb. 19, 2009 (CN) 2009100773846
Jul. 27, 2009 (CN) 2009100896371
Jul. 27, 2009 (CN) 2009100896386

(51) Int. Cl. B32B 21/00; B27J 7/00; B27M 3/00; B27M 1/08

(52) U.S. Cl. 428/136; 428/131; 428/155; 144/333; 144/2.1

(57) ABSTRACT

The present invention provides a bamboo based panel unit comprising a hunk bamboo bundle mat and an oriented bamboo fiber mat (OBFM). Series of dotted and/or linear shaped cracks are formed on the cylinder wall of a semicircular bamboo tube which is split and whose inner nodes are removed. The upper surface and the lower surface of the bamboo based panel unit comprise an outer layer and an inner layer of said bamboo, wherein, a waxy layer and a siliceous layer are removed respectively therefrom.

### FIELD OF THE INVENTION

The present invention relates to the production technology field of bamboo-based panels. Specifically, the present invention provides a bamboo-based panel unit, a method for manufacturing the bamboo-based panel unit, and an apparatus for manufacturing the component bamboo-based panel unit.

The bamboo-based panel unit comprises a hunk bamboo bundle mat and an oriented bamboo fiber mat.

### BACKGROUND OF THE INVENTION

Since bamboo has such advantages as fast growth, high strength and toughness, it is widely used in producing bamboo-based panels. According to the varieties of raw materials, the geometry of component units and the structure of panels, the bamboo-based panels can be divided into 5 categories: bamboo plywoods, laminated bamboo lumbers, bamboo particle boards, bamboo scrimbers and wood-bamboo composite panels, and the component unit is a very important section of manufacturing said bamboo-based panel. At present, the component units of the bamboo-based panels are mainly the bamboo strips, bamboo curtains and bamboo mats woven from bamboo strips, bamboo sheets, bamboo bundles, and so on. The bamboo strip is a kind of long strip of bamboos with a certain cross-sectional shape and size, which is made via cutting longitudinally the bamboo by a cleaver or a coned scribe wheel. The bamboo strip is divided into 3 categories: radial bamboo strips, tangential bamboo strips and filamentous bamboo strips, and the geometric dimensions of the cross section is as follows: the width is 3 to 20 mm, and the thickness is 0.5 to 4.0 mm. The utilization of bamboo strips, especially radial bamboo strips, is high. However, due to the low production efficiency of bamboo strips, the bamboo strip is mainly used in manufacturing such low value-added products as bamboo plywoods, laminated bamboo strip lumbers and bamboo mat plywoods. The bamboo sheet is a kind of long strip bamboo which is mainly processed by debris cutting, and this kind of long strip bamboo has the following characteristics: the size of the cross-section is bigger, and most of the cross-sections are rectangular. Usually, the method for manufacturing bamboo sheets can be divided into two kinds, flattening-planing and sawing-planing. Because of the cracks and deformation during or after the flattening process, the flattening-planing method has been eliminated. Presently, sawing-planing method is mainly used. The sawing-planing method is as follows: the bamboo is split into bamboo sheets with the width of 15 to 30 mm, and the outer layer of the bamboo is firstly planed, then the inner layer of bamboo. The thickness of the bamboo sheet after planing is 2 to 8 mm, and no residual outer layer or inner layer of bamboo is allowed on said bamboo sheet after planing. The bamboo sheet is mainly used to produce laminated bamboo lumbers and bamboo floorings, but as for such component unit, the utilization of bamboo is low, and there are high qualified requirements for bamboos.

Bamboo bundles are a component unit of bamboo scrimbers. At present the industrial production process of bamboo bundles is as follows: the bamboo is sawn into bamboo segments, after the inner and outer nodes are removed, the bamboo segment is split into bamboo sheets with the width of 10 to 30 mm and thickness of 2 to 3 mm; after the outer and inner layer of said bamboo are removed, then the bamboo sheet is put into a pressure wire machine to fluff into bundle structural units. The above component unit of bamboo is long strip structural units by splitting the bamboo. Because the outer layer and the inner layer of said bamboo are difficult to be glued, and the outer layer and the inner layer of said bamboo show large different physical and mechanical properties compared with the main part of said bamboo, when the above structural unit is used to manufacture panels, the inner layer and outer layer of said bamboo must be removed in the process of structural units so as to meet the physical and mechanical properties of bamboo panels. For the Phyllostachys heterocycla var. pubescen with a larger diameter and a thicker bamboo wall, Phyllostachys heterocycla var. pubescen the thickness of the outer layer and inner layer of said bamboo accounts for 15% to 20% of the bamboo wall thickness, but for the miscellaneous bamboo with a smaller diameter and a thinner bamboo wall, the thickness of the outer and inner layer of said bamboo can account for about 50% of the bamboo wall thickness. It is because of the removal of the outer layer and inner layer of said bamboo that only the Phyllostachys heterocycla var. pubescen is used in large-scale industrial applications in China, but the yield of the Phyllostachys heterocycla var. pubescen is about 20% to 30% of the yield of bamboos in China. However, the bamboo with a smaller diameter and the miscellaneous bamboo with a larger diameter such as bambusa Dendrocalamopsis oldhamii, Dendrocalamus and so on, which account for 70% to 80% of the total yield, can not be used in large-scale industrial applications. The Chinese patent CN02120518.3 provides a method for manufacturing the smaller-diameter bamboos with the diameter less than 80 mm, which comprises: removing the outer layer of bamboo by outer layer removed apparatus or sandblasting, splitting the bamboo into semicircular bamboo tubes by bamboo-splitting machine, rolling the semicircular bamboo tube into horizontal continuous, longitudinal loose and cross linked bamboo bundles by bamboo rolling machine. Although the utilization of bamboo in the above method is increased, the production efficiency of said method is low because the process for removing the outer layer of bamboo is somehow complex.

### SUMMARY OF THE INVENTION

The object of the present invention is to improve the existing technology; in particular, the invention provides a bamboo-based panel unit which comprises a hunk bamboo bundle mat and an oriented bamboo fiber mat (OBFM).

Another object of the present invention is to provide a method for manufacturing said component unit of bamboo-based panels.

Further object of the present invention is to provide an apparatus for manufacturing the component unit of bamboo-based panels.

The objects of the present invention can be achieved by providing a hunk bamboo bundle mat, wherein dotted and/or linear shaped cracks are formed on the cylinder wall of a semicircular bamboo tube which is split and whose inner nodes are removed so as to form netty structural hunk bamboo bundle mats; the upper surface and the lower surface of said hunk bamboo bundle mat comprise an outer layer and an inner layer of bamboos, wherein, a waxy layer and a siliceous layer are removed respectively therefrom;

the width of said hunk bamboo bundle mat can be 2 to 5 times the arc length of said original split semicircular bamboo tubes according to the density of cracks in said hunk bamboo bundle mat;

the width of said hunk bamboo bundle mat can reach 50 to 700 mm;

the bamboo bundles are formed between the adjacent cracks, and the diameter of said bamboo bundles is from 0.10 to 5 mm.

The method for manufacturing said hunk bamboo bundle mat in the present invention comprises:

the bamboo is sawn into bamboo tubes with the length of 1.5 to 20 m, which are then longitudinally split into two semicircular bamboo tubes, after the inner nodes being removed, the semicircular bamboo tube is fluffed by a fluffer, then dotted and/or linear shaped cracks are formed on the surfaces of the outer layer and inner layer of said bamboo, and the hunk bamboo bundle mat with netty structure is formed by the interlaced bundles and comprises the outer layer, the main part and the inner layer of said bamboo, and the upper surface and the lower surface of said hunk bamboo bundle mat comprises the outer layer and the inner layer of said bamboo, wherein, a waxy layer and a siliceous layer are removed respectively therefrom;

said fluffer includes driving rollers and fluffing rollers which are rotary and fixed horizontally on the support frame, and there is a certain clearance between said driving roller and fluffing roller; said driving roller can be connected to the motor by decelerated transmission device, several fluffing teeth are distributed in the circumferential surface of said fluffing roller and arranged in a row; cutting edges are arranged in said fluffing teeth and extend along the circumferential direction of said fluffing roller with intervals between the teeth, and several rows of said cutting edges are distributed along the axial direction of said fluffing roller;

the semicircular bamboo tube with their inner nodes removed is fed into the clearance between said driving roller and said fluffing roller with perpendicular to the axial direction of said fluffing roller, then passed through the clearance by the drive of said driving roller;

during the fluffing process, the semicircular bamboo tube is fluffed for several times with the outer layer surface and inner layer surfaces of the bamboo tube towards said fluffing roller respectively.

The arc length L₂ of said fluffing teeth is 1.1 to 3 times the arc length L₁ of the distance between the teeth in the circumferential direction of said fluffing roller.

The height H of said fluffing teeth in said fluffing roller is 0.5 to 0.75 times the bamboo wall thickness.

The perpendicular distance B1 between the teeth tips of the adjacent rows of fluffing teeth in said fluffing roller is 0.5 to 1.5 times said fluffed bamboo wall thickness.

The fluffer in the present invention is used in manufacturing the hunk bamboo bundle mat, the fluffer comprises the motor, main decelerator, transmission device, driving roller, fluffing roller, fluffing roller support frame and adjusted pad, wherein said driving roller and said fluffing roller are rotary and fixed horizontally on the support frame with a certain clearance between them, said driving roller can be connected to said motor by decelerator, several fluffing teeth are distributed in the circumferential surface of said fluffing roller and arranged in a row; the cutting edges are arranged in said fluffing teeth and extend along the circumferential direction of the fluffing roller with intervals between the teeth, and several rows of said cutting edges are distributed along the axial direction of said fluffing roller; said fluffing roller is special shaped gear shafting, said special shaped gear shafting is composed of a gear shaft with locking screw on its two ends and several special shaped gears which are fixed on the gear shaft by keys; several fluffing teeth are distributed uniformly in the circumferential direction of each special shaped gear, said fluffing teeth and the cutting edges in the fluffing teeth extend along the circumferential direction of the gear with intervals between the teeth; said fluffing teeth of said special shaped gear are staggered along the axial direction.

The specific arrangement can be as follows: said special shaped gears includes A-type and B-type, which are alternately fixed in the gear shaft, several fluffing teeth are distributed uniformly in the circumferential direction of special shaped gears of said A-type and B-type and arranged in a row in which the tooth shape, size and space between teeth are all the same; when the fluffing teeth of said A-type and B-type special shaped gear are aligned, the center angles corresponded to the central lines of the keyways have a 180°/n difference with each other, wherein represents the number of the fluffing teeth, and the keyways on the gear shaft corresponded to each said special shaped gear are straight keyways, so the fluffing roller with each row of fluffing teeth staggeredly arranged in the axial can be formed by the alternate assembling of A-type and B-type gear. Said driving roller is a twist roller with knurling on the roller surface

The arc length L₂ of said fluffing teeth, i.e. the arc length of cutting edges L₂, is 1.1 to 3 times the arc length L₁ of the distance between the teeth.

The diameter of said fluffing roller is from 100 to 200 mm, and the diameter of said driving roller is 1.5 to 2.5 times that of said fluffing roller.

The thickness of B-type special shaped gear, which is 2.5 to 18 mm, is 0.5 to 1.5 times the bamboo wall thickness. For example, the wall thickness of the Phyllostachys heterocycla var. pubescen is about 10 mm, and the thickness of special shaped gear is 12 mm; the wall thickness of the Neosinocalamus affinis is 6 mm, and the thickness of special shaped gear is 5 mm.

The axial perpendicular distance B₁ between the teeth tips of the adjacent special shaped gear in said fluffing roller is 2.5 to 18 mm, i.e. B₁ is 0.5 to 1.5 times the bamboo wall thickness. For example, the wall thickness of the Phyllostachys heterocycla var. pubescen is about 10 mm, and the axial distance between the adjacent teeth is 12 mm; the wall thickness of Neosinocalamus affinis is 6 mm, and the axial distance between the adjacent teeth is 5 mm.

The height H of the fluffing teeth in said fluffing roller is 2 to 10 mm, i.e. H is 0.5 to 0.75 times the wall thickness of bamboo. For example, the wall thickness of the Phyllostachys heterocycla var. pubescen is about 10 mm, and the height of fluffing teeth is 6 mm; the wall thickness of Neosinocalamus affinis is 6 mm, and the height of fluffing teeth is 4 mm.

The tooth tip angle β is 70° to 120°; the tooth angle γ is 20° to 60°; the tooth bevel angle a is 30° to 80°.

The present invention provides an oriented bamboo fiber mat (OBFM), wherein series of longitudinal and discontinuous cracks with uneven thickness are arranged on the upper surface, lower surface and the cylinder wall of semicircular bamboo tubes respectively which is split and whose inner nodes are removed; bamboo fibers are formed between the adjacent said cracks.

Said fiber contains 1 to 5 vascular bundles and several parenchyma tissues.

The bamboo-based panel composed by an oriented bamboo fiber mat unit (OBFM) can be used for manufacturing bamboo fiber reinforced composites.

A method for manufacturing the oriented bamboo fiber mat comprises the following steps:

1) Raw Materials Preparing

wherein the bamboos such as Phyllostachys heterocycle var. pubescen, Dendrocalamus sinicus, Dendrocalamopsis oldhami, Neosinocalamus affinis, Dendrocalamus latiflorus, Phyllostachys Praecox and Phyllostachys are used as raw materials, the bamboo is sawn into bamboo tubes with the length of 1.5 to 20 m, which is then longitudinally split into two semicircular bamboo tubes along the diameter, and the inner nodes of semicircular bamboo tube are removed;

2) The Inner Arc Surface of the Semicircular Bamboo Tube Fluffing

wherein one end of a semicircular bamboo tube is pushed into the clearance between driving roller and fluffing roller with its inner arc surface towards the fluffing roller.

While the driving roller is dragging the semicircular bamboo tube parallelly forward, series of longitudinal and discontinuous cracks with uneven thickness are arranged on the inner surface of semicircular bamboo tubes by local longitudinal cutting and radial extruding of the different position in the inner arc surface of said semicircular bamboo tubes, however, the outer surface of the semicircular bamboo tubes still keeps with relatively complete piece-shape structure, meanwhile, the inner arc surface of semicircular bamboo tube is cut, split and extruded by fluffing roller and the outer arc surface is frictionized by driving roller, then the waxy layer and the siliceous layer of semicircular bamboo tube are partly removed, cracked, fragmented or crushed; with above method, said semicircular bamboo tube is fluffed for several times;

3) The Outer Arc Surface of the Semicircular Bamboo Tube Fluffing

wherein said semicircular bamboo tube with fluffed inner arc surface turns 180 degree, which is pushed into the clearance between driving roller and fluffing roller with the outer surface towards said fluffing roller of the above fluffer or the same fluffer as the above; with the above procedure, series of uneven thickness, discontinuous and longitudinal cracks are arranged on the outer surface, meanwhile, the waxy layer in the outer surface of semicircular bamboo tubes are cut, split and extruded by fluffing roller and the inter surface is frictionized by a driving roller, the waxy layer and the siliceous layer of said semicircular bamboo tubes are partly removed, cracked, fragmented or crushed; with the above method, said semicircular bamboo tube is fluffed for several times;

step 2) and step 3) are repeated to fluff the semicircular bamboo tubes for several times, series of longitudinal and discontinuous cracks with uneven thickness and series of longitudinal continuous fibers with uniform thickness are formed on the outer layer surface, inner layer surface and cylinder wall of semicircular bamboo tubes respectively, said cracks and said fibers are interlaced to form netty structural oriented bamboo fiber mats (OBFM).

The present invention provides a fluffer for an oriented bamboo fiber mat (OBFM), which comprises a bed frame, a decelerator and several driving rollers. The two ends of each driving roller are pin jointed on the bed frame in the same level, and one end of one of said driving rollers connects with the output parts of the decelerator. Several parallel fluffing rollers are respectively and correspondingly pin jointed on the bed frame and above said driving rollers, and there is a clearance between said fluffing rollers and said driving rollers. Said fluffing roller is composed of several gears and a spline shaft. Several fluffing teeth are distributed with intervals between the teeth in the periphery of said special shaped gear, said fluffing teeth in adjacent special shaped gears are stagger assembled and fixed on the spline of the spline shaft.

The present invention provides another fluffer for the oriented bamboo fiber mat (OBFM), which comprises a bed frame, a decelerator and several driving rollers. The two ends of each driving roller are respectively pin-jointed on the bed frame and arranged with intervals between the teeth in the upper and lower levels. The two ends of each driving roller are pin jointed horizontally on the bed frame, and one end of one of the driving rollers connects with the output parts of the decelerator. Several fluffing rollers are respectively pin jointed on the bed frame and correspondingly above and below said driving rollers, and there is a clearance between said fluffing roller and said driving roller. Said fluffing roller is composed of several gears and a spline shaft, several fluffing teeth are distributed in the periphery of said special shaped gears with intervals between the teeth, and said fluffing teeth at said adjacent special shaped gears are assembled and fixed on the spline of the spline shaft with intervals between the teeth.

The tip shape and the arc length of said fluffing teeth are the same or different from each other.

The cutting edges are arranged in said fluffing teeth tips.

The height of said fluffing teeth is 0.5 to 0.75 times the bamboo wall thickness of the semicircular bamboo tube.

The length of the fluffing teeth is 1.1 to 1.3 times the longitudinal distance between the teeth.

The convex roller is used as driving roller, i.e. the surface of the driving roller has uniform convex pocks.

The waxy layer on the outer layer of bamboo and the silicon layer on the inner layer of said bamboo can also be removed by the oriented bamboo fiber mat (OBFM) Huffer.

Since the waxy layer on the outer layer of bamboo and the silicon layer on the inner layer of said bamboo have been removed, as well as the width of the hunk bamboo bundle mat after fluffing treatment is 2 to 5 times the semicircular bamboo tubes, the main part of the bamboo with good bonding performance are exposed more fully to the outer surface, thereby the effective bonding area of bamboo is increased and the impregnation path and bonding performance of said bamboo are improved, then the hunk bamboo bundle mat with good bonding performance in the present invention can be used to manufacture bamboo-based panels. During the above manufacturing process, the outer layer and inner layer of said bamboo don't have to be removed, the process is with easy operation and high production efficiency, and the small-diameter bamboos can also be used. The fluffer in the present invention with its special fluffing roller can make the waxy and silicon layers easily to be removed, and expand the width of the bamboo bundle mat to 2 to 5 times the arc length of said original semicircular bamboo tubes, the main part of bamboo is exposed more fully, therefore the production efficiency is higher.

### DETAILED DESCRIPTION OF THE DRAWINGS

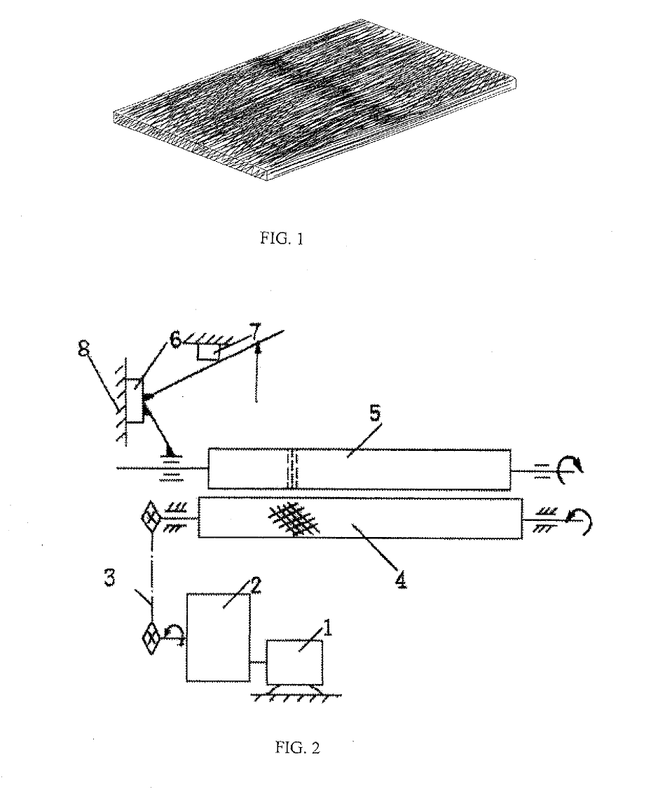

FIG. 1 is the structure diagram of the hunk bamboo bundle mat according to the present invention;

FIG. 2 is the structure diagram of the fluffer used in manufacturing the hunk bamboo bundle mat;

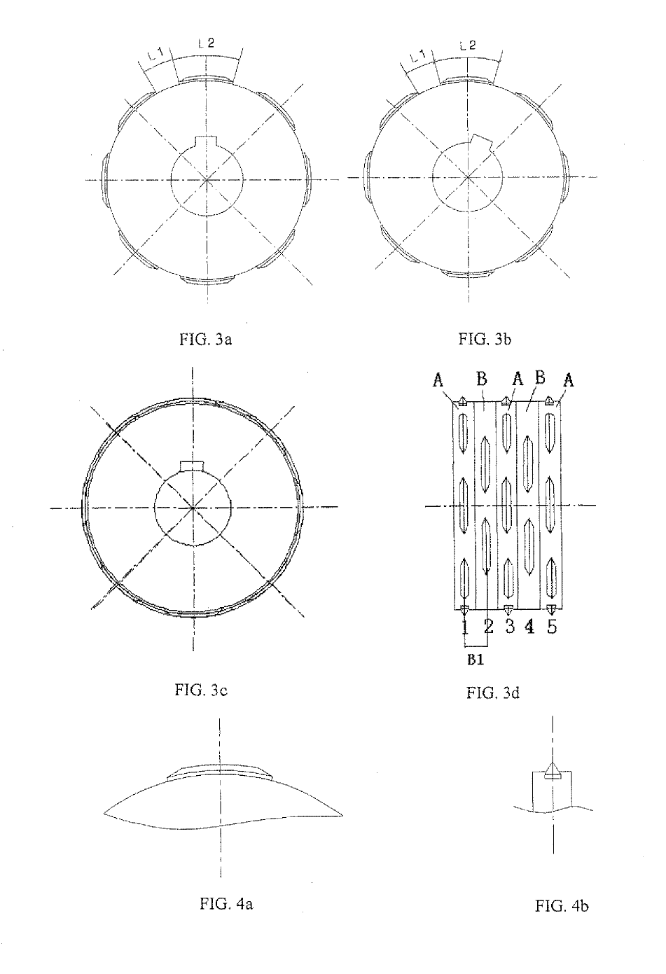

FIG. 3a is the structure diagram of A-type special shaped gear;

FIG. 3b is the structure diagram of B-type special shaped gear;

FIG. 3c is the structure diagram of the special shaped gear assembled on the fluffing roller of the fluffer shown in FIG. 2;

FIG. 3d is the side view of the special shaped gear shown in FIG. 3c;

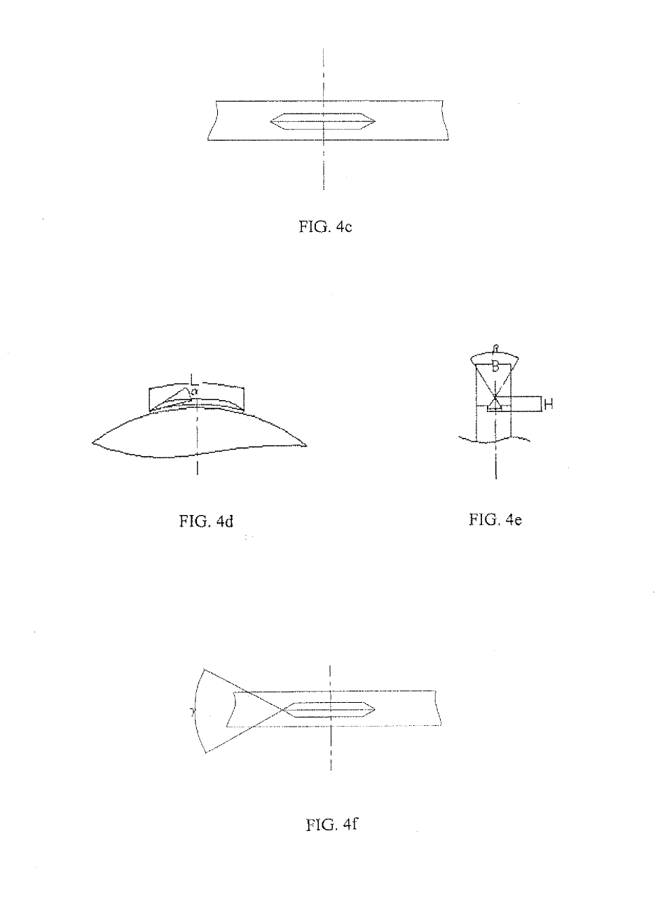

FIG. 4a is the structure diagram of the fluffing teeth at the special shaped gear showed in FIGS. 3a and 3b;

FIG. 4b is the side view of the fluffing teeth shown in FIG. 4a;

FIG. 4c is the top view of the fluffing teeth shown in FIG. 4a;

FIG. 4d is the schematic diagram of tooth bevel angle α of the fluffing tooth;

FIG. 4e is the schematic diagram of tooth tip angle β of the fluffing tooth;

FIG. 4f is the schematic diagram of tooth angle γ of the fluffing tooth;

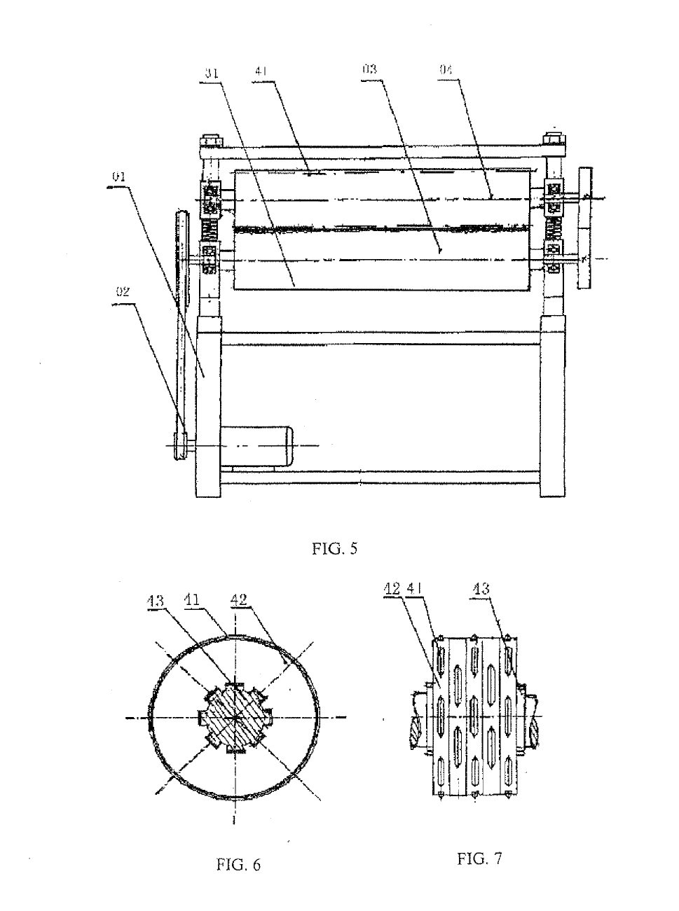

FIG. 5 is the structure diagram of the fluffer according to the present invention;

FIG. 6 is the cutaway view of the fluffer end face according to the present invention;

FIG. 7 is the arrangement diagram of fluffing teeth on the fluffing roller according to the present invention;

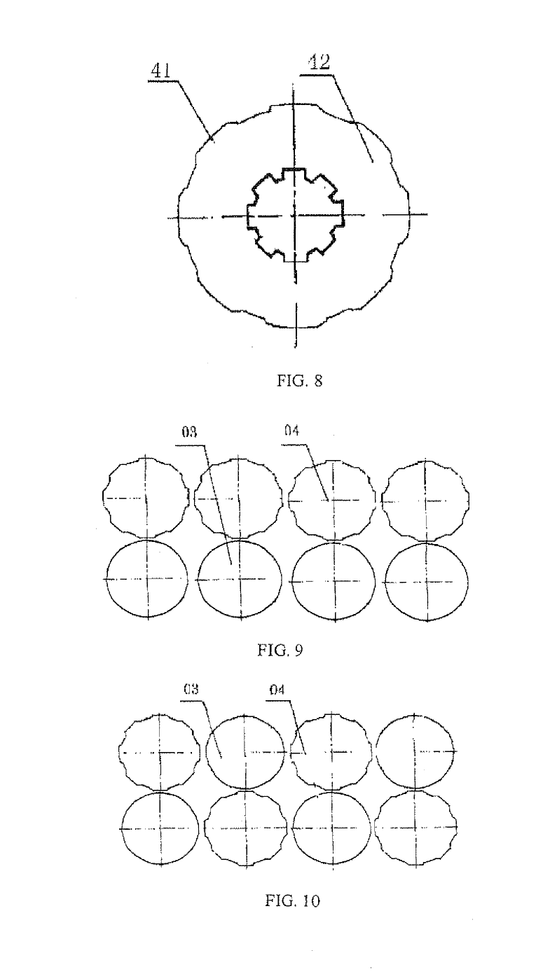

FIG. 8 is the schematic diagram of the gear end face of the fluffing roller according to the present invention;

FIG. 9 is the structure diagram of the fluffer end face according to example 3 of the present invention;

FIG. 10 is the structure diagram of the fluffer end face according to example 4 of the present invention.

### EMBODIMENT OF THE INVENTION

As shown in FIG. I, the present invention provides a hunk bamboo bundle mat, wherein dotted and/or linear shaped cracks are formed on the cylinder wall of a semicircular bamboo tube which is split and whose inner nodes are removed so as to form netty structural hunk bamboo bundle mats, and the upper surface and the lower surface of said hunk bamboo bundle mat comprises an outer layer and an inner layer of said bamboo, wherein, a waxy layer and a siliceous layer are removed respectively therefrom.

The width of said hunk bamboo bundle mat is 2 to 5 times are length of said original split semicircular bamboo tubes according to the density of said cracks in said hunk bamboo bundle mat.

The width of said hunk bamboo bundle mat can reach 50 to 700 mm.

The bamboo bundles are formed between adjacent said cracks, and the diameter of said bamboo bundles is from 0.10 to 5 mm.

A method for manufacturing the hunk bamboo bundle mat in the present invention comprises:

the bamboo is sawn into bamboo tubes with the length of 1.5 to 20 m, which is then longitudinally split into two semicircular bamboo tubes, after the inner nodes being removed, the semicircular bamboo tube is fluffed by the flutter, and then dotted and/or linear shaped cracks are formed on the surfaces of the outer layer and inner layer of said bamboo, and the hunk bamboo bundle mat with netty structure is formed by the interlaced bamboo bundles, and comprises the outer layer, main part and inner layer of said bamboo, and the upper surface and the lower surface of said hunk bamboo bundle mat comprises the outer layer and the inner layer of said bamboo, wherein, a waxy layer and a siliceous layer are removed respectively therefrom.

As shown in FIG. 2, said flutter includes the motor (1), main decelerator (2), transmission device (3), driving roller (4), fluffing roller (5), fluffing roller support frame (6) and adjusted pad (7), said driving roller (4) and said fluffing roller (5) with a clearance between them can be rotary and fixed horizontally on the support frame (6); said driving roller (4) can be connected to said motor (1) by decelerator (2); several fluffing teeth are distributed in the circumferential direction of said fluffing roller (5) and arranged in a row; the cutting edges are arranged in said fluffing teeth and extend along the circumferential direction of said fluffing roller with intervals between the teeth, and several rows of said cutting edges are distributed along the axial direction of the fluffing roller. Specifically, said fluffing roller is composed of special shaped gear shafting, said special shaped gear shafting includes a gear shaft with locking screw on its two ends and several assembled special shaped gears with intervals between the teeth which are fixed on the gear shaft by keys, said special gears include A-type special gears (as shown in FIG. 3a) and B-type special gears (as shown in FIG. 3b). Several fluffing teeth are distributed uniformly in the circumferential direction of said A-type special shaped gears and B-type special shaped gears and arranged in a row, in which the tooth shape, size and space between teeth are all the same; but when said A-type special shaped gears and B-type special shaped gears are aligned, the center angles corresponded to the keyway have a 180°/n (n represents the number of the fluffing teeth) difference with each other, and the keyways at said gear shaft corresponded to said gears are straight keyways, so said fluffing roller with axially staggered fluffing teeth as shown in FIG. 3c and FIG. 3d can be formed by A-type special shaped gears and B-type special shaped gears alternatively assembled on the gear shaft. Said driving roller is a twist roller with knurling on the roller surface.

The semicircular bamboo tube with their inner nodes removed is pushed into the clearance between said driving roller and said fluffing roller with perpendicular to the axial direction of said fluffing roller, and passed through the clearance by the drive of said driving roller.

During the fluffing process, the semicircular bamboo tube is fluffed for several times with the outer layer surface and inner layer surface of the bamboo tube towards said fluffing roller respectively.

The arc length (L₂) of said fluffing teeth is 1.1 to 3 times the arc length (L₁) of the distance between the teeth in the circumferential direction of said fluffing roller, as shown in FIGS. 3a and 3c.

As shown in FIG. 4e, the height (H) of said fluffing teeth in fluffing roller is 0.5 to 0.75 times the bamboo wall thickness.

The diameter of the fluffing roller is 100 to 200 mm, and the diameter of driving roller is 1.5 to 2.5 times that of fluffing roller.

As shown in FIG. 4c, the thickness (B) of said special shaped gear in said fluffing roller is 2.5 to 18 mm.

As shown in FIG. 3d, the perpendicular distance (B1) between the teeth tips of two adjacent fluffing teeth in said special shaped gear is 2.5 to 18 mm.

As shown in FIG. 4d, FIG. 4f and FIG. 4e, for the fluffing teeth in said fluffing roller, the tooth tip angle β is 70° to 120°; and/or the tooth angle γ is 20° to 60°; and/or the tooth bevel angle a is 30° to 80°.

The fluffing principle is as follows:

as shown in FIGS. 3c and 3d, while fluffing, the motor 1 (as shown in FIG. 2) drives the driving roller 4 to actively rotate by the main decelerator 2 and chain transmission device 3. The special shaped gear shafting 5 can be connected to the support frame 6, and the height of the special shaped gear shafting is adjusted through adjusting pad 7 to change the radial distance between said driving roller 4 and said special shaped gear shafting 5, once the distance is confirmed, the special shaped gear shafting (5) becomes the rigidity support. During the process of fluffing, the friction between the bamboo and driving roller (4) drives the bamboo into the clearance between driving roller (4) and fluffing roller (5), and then the bamboo drives the fluffing roller (5) to rotate at the same time. The cutting edges of A-type special gears 1, 3, 5, 7 . . . and B-type special gears 2, 4, 6, 8 . . . are distributed uniformly and staggeredly on the fluffing roller (5) as shown in FIG.

3d.

As shown in FIG. 3d, when the cutting edges of A-type special shaped gear 1, 3, 5, 7 . . . are cutting the bamboo, the cutting force is formed along the longitudinal direction of bamboo, due to the good performance of bamboo in longitudinal splitting, dotted and linear shaped cracks are formed in the bamboo along the longitudinal direction, at the same time, the spreading force is generated in radial direction to make the bamboo to flatten and extend along radial direction. The cutting edges of B-type special shaped gears 2, 4, 6, 8 . . . play a role in the extrusion and orientation. With the extrusion force, the effective cutting efficiency of A-type special gears cutting edges 1, 3, 5, 7, . . . is increased and the over-extension of cracks is prevented, which contribute to form interlaced netty structure and play a location role in preventing the collaring formed by fluffed bundles, When the fluffing roller rotate 360°/n (n represents the number of fluffing teeth), the cutting edges of A-type special shaped gears 1, 3, 5, 7 . . . are the teeth for extrusion and orientation, then the cutting edges of B-type special shaped gears 2, 4, 6, 8 . . . are the fluffing teeth, and such transformation is alternately made. If there are no bamboos to fluffed, the fluffing roller 5 stops rotation without the driving force. With above fluffing process, the bamboo outer and inner surfaces are fluffed for several times by the fluffer to complete the fluffing; therefore, the hunk bamboo bundle mat is fainted.

The twist roller is used as driving roller, the friction between the bamboos and driving roller is increased, therefore, the fluffing power is increased.

The principles for removing the waxy layer and silicon layer are as follows:

1. the circumferential special shaped cutting edges which are uniformly and staggeredly distributed on the circumferential surface of the fluffing roller 5 act during the fluffing process, then the tension and relaxation force are formed on the fluffing surface, which contribute to make the waxy and silicon layers on the outer layer and inner layer of said bamboo loosened and removed; the twist roller is used as driving roller to make the loose waxy layer and siliceous layers removed further under friction, so even if the outer and inner layer of said bamboo are not removed, the waxy and siliceous layers on the outer and inner layer of bamboo can be removed automatically with the fluffing process so as to improve the bonding performance;

2. the semicircular bamboo tube is fed into flutter to fluff the inner layer with the inner surface towards the fluffing roller and the outer surface towards the driving roller; after fluffing for several times, series of dotted and/or linear shaped cracks and radial spreading are formed on the inner surface under longitudinal cutting and radial spreading. However, the outer surfaces still remains relatively complete piece-shape structure; the structure of semicircular bamboo tubes is converted from the structure with outer and inner surface of said bamboo as outer arc and inner arc surface respectively into the structure with the inner surface and outer surface of bamboo as outer are and inner arc surface respectively; next , the said semicircular bamboo is fed into the fluffer to fluff the outer layer with the outer surface towards fluffing roller and the inner surface towards the driving roller, after fluffing for several times, the arc structure of the hunk bamboo bundle mat faces towards the inner layer of said bamboo again with the further increase of the fluffing degree of the outer layer, such alternate fluffing is repeated for several times and the fluffing process is completed; during such process, the are orientation of the outer and inner layer of said bamboo is changed, which will make the waxy layer and silicon layer on the outer and inner layer of said bamboo loosened and removed, and the uninterrupted friction between driving roller and inner layer or outer layer of said bamboo make the loose waxy layer and loose silicon layers to be removed further; besides, after such repeated fluffing, the width of the hunk bamboo bundle mat is 2 to 5 times the arc length of said semicircular bamboo tube, and the main part of said bamboo with good bonding performance is exposed to the outer surface, thereby the effective bonding area of said bamboo is increased and the impregnation path of said bamboo is improved.

### EXAMPLE 1

The fluffer for the hunk bamboo bundle mat is composed of the motor 1, main decelerator 2, chain transmission device 3, driving roller 4, fluffing roller 5, fluffing roller support frame 6 and adjusted pad 7, wherein said fluffing roller is composed of special shaped gear shafting, and said special shaped gear shafting includes a gear shaft with locking screw on its two ends and 60 special shaped gears fixed on the gear shaft by keys and staggeredly assembled, said special shaped gears include A-type special shaped gears and B-type special shaped gears. 8 fluffing teeth are distributed uniformly on the circumferential direction of the special shaped gears, and the difference of the angles between the keyways centre lines of special shaped gears of A-type and B-type is 22.5°. The arc length L₂ of said fluffing teeth is 2 times the arc length L₁ of the distance between the teeth. The diameter of the fluffing roller and driving roller are respectively 138 mm and 276 mm. The thickness B of special shaped gear is 12 mm, the perpendicular distance B1 between the teeth tips of two adjacent fluffing teeth is 12 mm, and the height H of said fluffing teeth is 6 mm. The tooth tip angle β is 90°, the tooth angle γ is 30°, and the tooth bevel angle a is 60°. The twist roller is used as a driving roller.

For the large diameter bamboos, such as Phyllostachys heterocycla var. pubescen, Dendrocalamus sinicus and Dendrocalamopsis oldhami, the wall thickness are from 9 to 13 mm, and the diameter is from 100 to 120 mm. Such bamboos are sawn into 8 m bamboo tubes, which are then longitudinally split into two semicircular bamboo tubes.

The semicircular bamboo tube is fed into the fluffer to fluff the inner layer with the inner surface towards the fluffing roller and the outer surface towards the driving roller. After fluffing for 2 times, series of dotted and/or linear shaped cracks and radial spreading are made on the inner surface by longitudinal cutting and radial spreading, however, the outer surfaces still remains relatively complete piece-shape structure. The structure of semicircular bamboo tubes is respectively converted from the structure with the outer and inner surface of bamboo as outer arc and inner arc surface respectively into the structure with the inner surface and outer surface of bamboo as outer arc and inner arc surface. Then the said semicircular bamboo is fed into the fluffer to fluff the outer surface with the outer surface towards the fluffing roller and the inner surface towards the driving roller, after fluffing for 2 times, the arc structures of the hunk bamboo bundle mat faces towards the inner layer of said bamboo again with the further increase of the fluffing degree of the outer layer. Repeating above alternate fluffing for 3 times, the fluffing process is completed, a hunk bamboo bundle mat is formed.

The length, width and thickness of said hunk bamboo bundle mat are respectively 8 m, 450 to 600 mm and 9 to 20 mm. Said hunk bamboo bundle mat with netty structure is composed of interlaced bamboo bundles and comprises the main part, outer layer and inner layer of said bamboo. The upper surface and the lower surface of said hunk bamboo bundle mat include the outer layer and inner layer of said bamboo, wherein, a waxy layer and a siliceous layer are removed respectively therefrom. The diameter of each bamboo bundle is from 0.1 to 2 mm.

### EXAMPLE 2

As shown in FIGS. 2, 3a, 3b, 3c, 3d and 4a to 4f, the fluffer for the hunk bamboo bundle mat is composed of the motor 1, main decelerator 2, chain transmission device 3, driving roller 4, fluffing roller 5, fluffing roller support frame 6 and adjusted pad 7. Said fluffing roller is composed of special shaped gear shafting, said special shaped gear shafting include a gear shaft with locking screw on its two ends and 40 special shaped gears which are fixed and assembled with intervals between the teeth on the gear shaft by keys, said special shaped gears include special shaped gears of A-type and B-type special shaped gears. 8 fluffing teeth are uniformly distributed on the circumferential direction of the special shaped gears, and the difference of the angles between the keyways centre lines of special shaped gears of A-type and B-type is a 22.5°. The arc length L₂ of said fluffing teeth is 1.5 times the arc length L₁ of the distance between the teeth. The diameter of said fluffing roller is 128 mm, and the diameter of said driving roller is 2.5 times of that of said fluffing roller; the thickness B of said special shaped gear is 5 mm, the perpendicular distance B1 between adjacent teeth tips in fluffing roller is 5 mm, the height of the fluffing teeth is 3 mm, the tooth tip angle β is 90°, the tooth angle γ is 30° , and the tooth bevel angle α is 60°. The twist roller is used as driving roller.

The wall thickness of the kind of small-diameter bamboo such as Neosinocalamus affinis, Phyllostachys praecox, Phyllostachys and so on, is from 3 to 5 mm and the diameter is from 50 to 80 mm. Such bamboo is sawn into 2.5 m bamboo tubes, which are then longitudinally split into two semicircular bamboo tubes. The semicircular bamboo tube is fed into the fluffer to fluff the inner surface with the inner surface towards the fluffing roller and the outer surface towards the driving roller. After fluffing for 2 times, series of dotted and/or linear shaped cracks and radial spreading are made on the inner surface by longitudinal cutting and radial spreading, however, the outer surfaces still remains relatively complete piece-shape structure. The structure of semicircular bamboo tubes is respectively converted from the structure with the outer and inner surface of bamboo as outer arc and inner arc surface respectively into the structure with the inner surface and outer surface of bamboo as outer arc and inner arc surface. Then the said semicircular bamboo is fed into the fluffer to fluff the outer surface with the outer surface towards the fluffing roller and the inner surface towards the driving roller, after fluffing for 2 times, the arc structures of the hunk bamboo bundle mat faces towards the inner surface of bamboo again with the further increase of the fluffing degree of the outer surface. Repeating above alternate fluffing for 4 times, the fluffing process is completed, and a hunk bamboo bundle mat is formed.

The length, width and thickness of said hunk bamboo bundle mat are respectively 2.5 m, 250 to 400 mm and 2 to 5 mm. Said hunk bamboo bundle mat with netty structure is composed of interlaced bamboo bundles, which comprise the main part, outer layer and inner layer of bamboo. The upper surface and the lower surface of said hunk bamboo bundle mat include the outer and inner layer of said bamboo, wherein, a waxy layer and a siliceous layer are removed respectively therefrom; the diameter of each bamboo bundle is from 0.05 to 1 mm.

### EXAMPLE 3

The oriented bamboo fiber mat (OBFM) in the present invention comprises series of longitudinal and discontinuous cracks with uneven thickness and series of longitudinal and continuous fibers with uniform thickness, said cracks and said fibers are respectively formed on the upper surface, lower surface and cylinder wall of semicircular bamboo tube, and said cracks and said fiber are interlaced to form netty structure, as showed in FIG. 1. On the surface of said oriented bamboo fiber mat (OBFM), the inner layer and outer layer of semicircular bamboo tubes are cut, split and extruded, so the waxy layer and siliceous layer of semicircular bamboo tubes are partly removed, cracked, fragmented or crushed. Said cracks are formed by processing the inner and outer arc surface of the semicircular bamboo tube respectively with fluffer. The fibers are formed between the adjacent cracks, and said fiber contains 1 to 5 vascular bundles and several parenchyma tissues. The width of said oriented bamboo fiber mat is 2 to 5 times of the arc length of said original split semicircular bamboo tube.

The steps of a typical example for manufacturing said oriented bamboo fiber mat (OBFM) are as follows:

1. using such bamboo as Phyllostachys heterocycla var. pubescen, Dendrocalamus sinicus, Dendrocalamopsisoldhami,Neosinocalamusaffinis, Dendrocalamus latiflorus, Phyllostachys praecox and Phyllostachys, said bamboo is sawn into bamboo tubes with the length of 1.5 to 20 m, which is then split longitudinally into two semicircular bamboo tubes, and the inner nodes of said semicircular bamboo tube are removed;

2. The Inner Arc Surface Fluffing

wherein one end of the semicircular bamboo tube is pushed into the clearance between the driving roller and fluffing roller with the inner surface towards the fluffing roller of the fluffer; when the driving roller 03 is dragging the semicircular bamboo tube parallelly forward, as several uniformly distributed fluffing teeth 41 with cutting edges are arranged on the outer circumference of said fluffing roller 04, wherein the length of fluffing teeth is 1.1 to 3 times the longitudinal distance between the teeth and the height is 0.5 to 0.75 times said semicircular bamboo wall thickness, series of uniform and discontinuous cracks are arranged on said inner arc surface by local longitudinal cutting and radial extruding the different position in the inner arc surface of said semicircular bamboo tube with the said fluffing teeth 41, as showed in FIG. 1, however, the outer surface of said semicircular bamboo tube will remain relatively complete piece-shape structure; said semicircular bamboo tube is fluffed for several times with the above method; meanwhile, during the fluffing process by combining the fluffing teeth 41 and the driving roller 04, wherein the convex roller is used as the driving roller, the siliceous layer on the inner surface of semicircular bamboo tubes is cut, split and extruded so as to be partly removed, cracked, fragmented or crushed, which can overcome such defects as poor wettability and low bonding performance of the inner surface, then the bonding performance can be improved;

the outer surface still remains relatively complete piece-shape structure, so the structure of semicircular bamboo tubes is respectively convert from the structure with the outer and inner surface of bamboo as outer arc and inner arc surface into the structure with the inner surface and outer surface of bamboo as outer arc and inner arc surface; so that the tensile force formed on the inner surface and extrusion force formed on the outer surface contribute to remove the waxy layer in the outer layer of said bamboo and the siliceous layer shed in the inner layer of said bamboo.

3. The Outer Arc Surface Fluffing

as the inner arc surface of said semicircular bamboo tube has fluffed, and the original outer surface of bamboo still remains relatively complete piece-shape structure, the structure of semicircular bamboo tube is respectively converted from structure with the outer and inner surface of bamboo as outer arc and inner arc surface into the structure with the inner surface and outer surface of said bamboo as outer arc and inner arc surface;

then, said semicircular bamboo tube with fluffed inner arc surface turns 180 , i.e. the corresponding outer arc surface of original semicircular bamboo tubes face towards said fluffing roller 04 of the above fluffer or the same fluffer as the above, and is pushed into the clearance between driving roller 03 and fluffing roller 04, using the same procedure as the above, therefore, the series of uniform and discontinuous cracks are arranged on corresponding said outer arc surface of original semicircular bamboo tubes, said semicircular bamboo tube is fluffed for several times with the above method;

meanwhile, during the fluffing process by combining the fluffing teeth 41 and the driving roller 03, wherein the driving roller is with uniform convex pocks on its surface, the waxy layer on the outer surface of semicircular bamboo tubes is cut, split and extruded so as to be partly removed, cracked, fragmented or crushed, which can overcome such defects as poor wettability and low bonding performances of said outer surface;

besides, the fluffing in step 2 and step 3 is repeated for several times, the semicircular bamboo tube is fluffed into the oriented bamboo fiber mat (OBFM), wherein the oriented bamboo fiber mat comprises series of longitudinal and discontinuous cracks with uneven thickness and series of longitudinal continuous fibers with uniform thickness, said cracks and said fiber are interlaced to form netty structure. Said fiber contains 1˜5 vascular bundles and several parenchyma tissues, and the width of said oriented bamboo fiber mat 1 is 2 to 5 times of the arc length of said semicircular bamboo tube 3, and the main part of said bamboo with good bonding performance is exposed to the outer surface, thus the effective bonding area of bamboo is increased and the impregnation path of bamboo is improved.

Said fluffer for an oriented bamboo fiber mat (OBFM) is composed of a bed frame 01, a decelerator 02, several driving rollers 03 and several fluffing rollers 04, as shown in FIGS. 5 to 8.

The bed frame 01 is a fixed device which supports the decelerator 02, several rotatable driving rollers 03 and several rotatable fluffing rollers 04. The bed frame belongs to the existing technology.

The decelerator 02 comprises a motor, a pair of chains or belt transmission device and power input device with gear transmission, which belongs to the existing technology.

Said driving roller 03 is the shaft roller with knurling globoidal 31 on its periphery. The two ends of each driving roller 03 are pin jointed on the bed frame 01 in the same level. The output part (big chain wheel or belt wheel) of the decelerator 02 can be connected to one end of one driving roller 03, then the driving roller (03) can be connected to adjacent driving rollers 03 which is in the same level with the driving roller by the transmission gear with the same number of teeth, or one end of each driving roller 03 can be connected to the decelerator 02, and the connection is sequentially concatenation, the purpose of the above is to make each driving roller 03 which is in the same level and arranged horizontally to rotate in the same speed. Generally, the diameter of driving roller 03 is 1 to 1.5 times that of fluffing roller 04.

Said fluffing roller 04 is composed of several special shaped gears 42 and a spline shaft 43. Several fluffing teeth 41 is distributed on the periphery of said special shaped gears 42, and said fluffing teeth 41 in adjacent special shaped gears 42 are staggeredly assembled and fixed on the spline of the spline shaft 43. The spline shaft 43 of said each fluffing roller 04 is horizontally to the upper of corresponding said driving roller 03 and pin jointed on the bed frame 01 with a certain clearance (which can be adjusted according to the thickness of the semicircular bamboo tube wall) between said fluffing roller and driving roller. The fluffing teeth 41 with cutting edges can cut longitudinally and extrude transversely the bamboo wall. The tip shape and the arc length of said fluffing teeth 41 in adjacent said gears42 can be the same or different from each other, which can be adjusted appropriately according to the different properties, hardness and different wall thickness of the bamboo. Generally, the arc length of the fluffing teeth 41 is 1.1 to 3 times of the arc length of the distance between teeth, and the height of fluffing teeth 41 is 0.5 to 0.75 times of bamboo wall thickness, which leads to that, appropriate cracks are formed on the bamboo wall by cutting and extrusion, but the bamboo wall is not wholly cut off. As shown in FIG. 9, several said fluffing rollers 04 are arranged horizontally on the bed frame 01 and above said driving roller 03, firstly, the inner arc surface (upper surface) of a semicircular bamboo tube is fluffed continuously, then said semicircular bamboo tube turn 180°, the outer arc surface (lower surface) of the semicircular bamboo tube is fluffed continuously.

In the example, not only the impregnation bonding area of the oriented bamboo fiber mat (OBFM) is increased, but also the longitudinal bamboo fiber strength is kept.

### EXAMPLE 4

The fluffer for said oriented bamboo fiber mat (OBFM) is comprised of a bed frame 01, a decelerator 02, several driving rollers 03 and several fluffing rollers 04, as shown in FIGS. 5 to 8.

The bed frame 01 is a fixed device which supports the decelerator 02, several rotatable driving rollers 03 and fluffing rollers 04. The bed frame belongs to the existing technology.

The decelerator 02 includes a motor, a pair of chains or belt transmission device and power input device with gear transmission, which belongs to the existing technology.

Said driving roller 03 is the shaft roller with knurling globoidal 31 on its periphery. The two ends of each driving roller 03 are respectively pin jointed on the upper and lower levels of the bed frame 01 with intervals between the teeth, and the output parts (big chain wheel or large belt wheel) of decelerator 02 connect with one end of one driving roller 03, then the driving roller can be connected to adjacent driving rollers 03 by the transmission gear with same number of teeth, and the connection is sequentially concatenation, the purpose of the above is to make the driving roller whose axes is arranged horizontally in the upper and lower level with interval to rotate in the same speed. Generally, the diameter of driving roller 03 is 1 to 1.5 times that of fluffing roller 04.

Said fluffing roller 04 is composed of several special shaped gears 42 and a spline shaft 43, several interval fluffing teeth 41 is distributed on the periphery of said special shaped gears 42, said fluffing teeth 41 in the adjacent special shaped gears 42 are staggeredly assembled and fixed on the spline of the spline shaft 43. Said spline shaft 43 is pin jointed on the bed frame 01 with parallel to the upper of one driving rollers 03, and there is a certain clearance (which can be adjusted according to thickness) between the spline shaft 43 and the driving rollers. The fluffing teeth 41 with cutting edges can cut longitudinally and extrude transversely the bamboo wall, and the tip shape and the arc length of said fluffing teeth 41 in adjacent said gears 42 are the same or different from each other, which can be adjusted appropriately according to the different properties, hardness and different wall thickness of bamboo. Generally, the arc length of fluffing teeth 41 is 1.1 to 3 times of the arc length of the distance between teeth, and the height of fluffing teeth 41 is 0.5 to 0.75 times of bamboo wall thickness, which leads to that, appropriate cracks are formed on the bamboo wall by cutting and extrusion, but the bamboo wall is not wholly cut off. As shown in FIG. 10, several said fluffing rollers 04 are arranged above and below corresponding each said driving rollers 03 with intervals between teeth, the inner arc surface (upper surface) and outer arc surface (lower surface) of semicircular bamboo tubes are fluffed successively with intervals between teeth, then the outer surface and inner surface of semicircular bamboo tubes can be fluffed by only one procedure. The fluffing process for the oriented bamboo fiber mat (OBFM) is simple, both timesaver and saving manual, then production efficiency can be higher.

In the example, the impregnation bonding area of the oriented bamboo fiber mat (OBFM) is increased, the longitudinal fiber strength of the bamboo is maintained, and the manufacturing process of the oriented bamboo fiber mat (OBFM) is simplified.

The operations and work principle of present invention, after the inner nodes removed, the semicircular bamboo tube with the length of 1.5 to 20 m is fed into the clearance between the driving rollers 03 and fluffing rollers 04 with perpendicular to the axial direction of said fluffing roller and the inner surface of bamboo towards the fluffing rollers 04; when the power of decelerator 02 input, the knurling globoidal 31 of the driving roller 03 pushes the semicircular bamboo tube into the clearance; the inner and outer surface of semicircular bamboo tubes are fluffed for several times by the fluffing teeth 41 respectively; series of discontinuous and discontinuous cracks with uneven thickness and the series of longitudinal continuous fibers with uniform thickness are formed on the upper surface, lower surface and cylinder wall of semicircular bamboo tubes respectively; said fiber contains 1˜5 vascular bundles and several parenchyma tissues; said cracks and said fiber are interlaced to form an oriented bamboo fiber mat (OBFM) with netty structure; meanwhile, the inner and outer surface of semicircular bamboo tubes are cut, split and extruded by fluffing roller and frictionized by driving roller, therefore, the waxy layer and the siliceous layer of semicircular bamboo tubes are partly removed, cracked, fragmented or crushed, which can overcome such defects of the inner and outer surface as poor wettability and poor bonding performance, finally, the bamboo can be fully utilized.

1. A hunk bamboo bundle mat, wherein dotted and/or linear shaped cracks are formed on the cylinder wall of a semicircular bamboo tube which is split and whose inner nodes are removed so as to form netty structural hunk bamboo bundle mats, and the upper surface and the lower surface of said hunk bamboo bundle mat comprise an outer layer and an inner layer of said bamboo, wherein, a waxy layer and a siliceous layer are removed respectively therefrom.

2. A hunk bamboo bundle mat according to claim 1, wherein the width of said hunk bamboo bundle mat is 2 to 5 times of the arc length of the original split semicircular bamboo tube according to the density of said cracks in said hunk bamboo bundle mat.

3. A hunk bamboo bundle mat according to claim 1, wherein the bamboo bundles are formed between the adjacent cracks and the diameter of said bamboo bundles is from 0.05 to 5 mm.

4. A method for manufacturing a hunk bamboo bundle mat comprises:
the bamboo is sawn into bamboo tube with the length of 1.5 to 20 m, which is then longitudinally split into two semicircular bamboo tubes, after the inner nodes removed,
the semicircular bamboo tube is fluffed by a fluffer, then dotted and/or linear shaped cracks are formed on the surfaces of the outer layer and inner layer of bamboo, and the hunk bamboo bundle mat with netty structure is formed by the interlaced bamboo bundles and said hunk bamboo bundle mat comprises the outer, the main part and the inner of the bamboo, and the upper surface and the lower surface of said hunk bamboo bundle mat comprises an outer layer and an inner layer of said bamboo respectively, wherein, a waxy layer and a siliceous layer are removed respectively therefrom;
said fluffer comprises driving rollers and fluffing rollers which are rotary and fixed horizontally on the support frame, and there is a clearance between driving rollers and fluffing rollers, and said driving roller can be connected to the motor by decelerated transmission device; several fluffing teeth are distributed in the circumferential direction of said fluffing roller and arranged in a row; cutting edges are arranged in said fluffing teeth and extend along the circumferential direction of said fluffing roller with intervals between teeth, and several rows of said cutting edges are distributed along the axial direction of said fluffing roller;
the semicircular bamboo tube without inner nodes is fed into the clearance between said driving roller and fluffing roller with perpendicular to the axial direction of said fluffing roller, then passed through the clearance by the drive of said driving roller;
during the fluffing process, the semicircular bamboo tube is fluffed for several times with the outer layer and inner layer of bamboo towards said fluffing roller respectively.

5. A method for manufacturing a hunk bamboo bundle mat according to claim 4, wherein the arc length L₂ of said fluffing teeth is 1.1 to 3 times the arc length L₁ of the distance between the teeth in the circumferential direction of said fluffing roller.

6. A method for manufacturing a hunk bamboo bundle mat according to claim 4, wherein the height H of the fluffing teeth in said fluffing roller is 0.5 to 0.75 times said bamboo wall thickness, or
the perpendicular distance B1 between the teeth tips of two adjacent fluffing teeth in said fluffing roller is 0.5 to 1.5 times the wall thickness of said fluffed bamboo.

7. An apparatus for manufacturing the hunk bamboo bundle mat, comprising a fluffer which comprises the motor, the main decelerator, the transmission device, the driving roller, the fluffing roller, the fluffing roller support frame and the adjusted pad; wherein said driving roller and said fluffing roller are rotary and horizontally fixed on the support frame, and there is a clearance between said driving rollers and fluffing rollers; said driving roller can be connected to said motor by a decelerated transmission device; several fluffing teeth are distributed in the circumferential direction of said fluffing roller and arranged in a row; the cutting edges are arranged in said fluffing teeth and extend along the circumferential direction of said fluffing roller with intervals between teeth, and several rows of said cutting edges are distributed along the axial direction of said fluffing roller; said fluffing roller is special shaped gear shafting, several said special shaped gears are fixed on the gear shafting, several fluffing teeth are distributed uniformly in the circumferential direction of each special shaped gear and arranged in a row, said fluffing teeth extend along the circumferential direction of the gear with intervals between teeth, the cutting edges in said fluffing teeth also extend along the circumferential direction with intervals between teeth, and said fluffing teeth of each said special shaped gear are staggered along the axial direction.

8. An apparatus according to claim 7, wherein said special shaped gear shafting is composed of a gear shaft with locking screw on its ends and several A-type special shaped gears and B-type special shaped gears which are fixed on the gear shaft by key and staggeredly assembled; several fluffing teeth are distributed uniformly in the circumferential direction of said A-type special shaped gear and said B-type special shaped gear and arranged in a row□in which the tooth shape, size and space between teeth are all the same; when the fluffing teeth of said A-type special shaped gear and B-type special shaped gear are aligned, the center angles corresponded to the central lines of the keyways have a 180°/n difference with each other, wherein n represents the number of the fluffing teeth, and the keyway on the gear shaft corresponded to each said special shaped gear are straight keyways so as to make the fluffing teeth to stagger in the axial direction.

9. An apparatus according to claim 7, wherein the height H of said fluffing teeth in fluffing roller is 0.5 to 0.75 times the wall thickness of said bamboo; and/or, the arc length L₂ of said fluffing teeth is 1.1 to 1.3 times the arc length L₁ of the distance between the teeth; and/or,
the thickness B of the special shaped gear is 0.5 to 1.5 times the wall thickness of said fluffed bamboo; and/or,
the perpendicular distance B₁ between the teeth tips in the special shaped gear is 0.5 to 1.5 times the wall thickness of said fluffed bamboo; and/or,
the diameter of said driving roller is 1.5 to 2.5 times that of said fluffing roller; and/or, said driving roller is a twist roller with knurling on the roller surface.

10. An apparatus according to claim 7, wherein for the fluffing teeth in said fluffing roller, the tooth tip angle p is 70° to 120°; and/or, the tooth angle y is 20° to 60°; and/or, the tooth bevel angle a is 30° to 80°.

11. An oriented bamboo fiber mat, wherein series of longitudinal and discontinuous cracks are arranged on the upper surface, lower surface and wall of the semicircular bamboo tube respectively which is split and whose inner nodes are removed; bamboo fibers are formed between the adjacent said cracks; said fiber comprises 1 to 5 vascular bundles and several parenchyma tissues.

12. A method for manufacturing said oriented bamboo bundle mat according to claim 11, wherein
1) Raw Materials Preparation
wherein the bamboo is sawn into bamboo tube with the length of 1.5 to 20 m which is then split longitudinally into two semicircular bamboo tubes, and the inner nodes are removed;
2) The Inner Arc Surface of the Semicircular Bamboo Tube Fluffing
one end of the semicircular bamboo tube is pushed into the clearance between driving roller and fluffing roller with its inner arc surface towards the fluffing roller, while the driving roller is dragging said semicircular bamboo tube parallelly forward, series of uneven thickness, discontinuous and longitudinal cracks are arranged on said inner arc surface of said semicircular bamboo tube by local longitudinal cutting and transversal extruding of the different position in the inner arc surface of said semicircular bamboo tube, but the outer surface of said semicircular bamboo tube still remains relatively complete piece-shape structure, meanwhile, the inner surface of semicircular bamboo tube is cut, split and extruded and the outer arc surface is frictionized by the driving roller, then the waxy layer and the siliceous layer of semicircular bamboo tube are partly shed, cracked, fragmented or crushed; said semicircular bamboo tube is fluffed for several times with the above method;
3) The Outer Arc of the Semicircular Bamboo Tube Surface Fluffing
said semicircular bamboo tube with the fluffed inner arc surface turns 180 degrees, which is fed into the clearance between driving roller and fluffing roller with the outer arc surface towards said fluffing roller of the above fluffer or the same fluffer as the above; using the same procedure as the above procedure, series of uneven thickness, discontinuous and longitudinal cracks are arranged on the outer arc surface of the corresponding original semicircular bamboo tube, meanwhile, the waxy layer in the outer surface of semicircular bamboo tube is cut, split and extruded by fluffing roller while the inter surface of bamboo in the inner arc surface is frictionized by driving roller, the waxy layer and the siliceous layer of said semicircular bamboo tube are partly removed, cracked, fragmented or crushed; said semicircular bamboo tube is fluffed for several times with the above method;
repeating step 2) and step 3) to fluff the semicircular bamboo tube for several times, series of discontinuous and longitudinal cracks with uneven thickness and series of longitudinal and continuous fibers with uniform thickness are formed on the outer surface, inner surface and cylinder wall of semicircular bamboo tubes respectively, said cracks and said fibers are interlaced to form netty structural oriented bamboo fiber mats.

13. A fluffer for manufacturing the oriented bamboo bundle mat according to claim 11, comprising a bed frame 01, a decelerator 02 and several driving rollers 03; the two ends of each driving roller 03 are pin jointed on the bed frame 01 in the same level, and one end of driving rollers 03 connects with the output parts of a decelerator 02, wherein several said fluffing rollers 04 are respectively, correspondingly and horizontally pin jointed on the bed frame 01 and are above several said driving rollers 03, and there is a certain clearance between said fluffing rollers 04 and said driving rollers 03; said fluffing roller 04 is composed of several special shaped gears 42 and a spline shaft 43; several fluffing teeth 41 are distributed in the periphery of said special shaped gears 42 with intervals between the teeth, and said fluffing teeth 41 in adjacent special shaped gears are staggeredly assembled and fixed on the spline of the spline shaft 43.

14. A fluffer for manufacturing the oriented bamboo bundle mat according to claim 11, comprising a bed frame 01, a decelerator 02 and several driving rollers 03; the two ends of each driving roller 03 are respectively pin jointed with intervals between the teeth on the upper and lower levels of the bed frame 01, and the two ends of each driving roller 03 are pin jointed horizontal on the bed frame 01; one end of said driving rollers 03 connects with the output part of decelerator 02; said fluffing rollers 04 are also respectively and correspondingly pin jointed on the bed frame 01 under several said driving rollers 03, there is a certain clearance between said fluffing rollers 04 and said driving rollers 03; said fluffing roller 04 is composed of several special shaped gears 42 and a spline shaft 43, several fluffing teeth 41 are distributed with intervals between the teeth in the periphery of said special shaped gears 42, and said fluffing teeth 41 in said adjacent special shaped gears 42 are staggeredly assembled and fixed on the spline of the spline shaft 43.

15. A fluffer for the oriented bamboo bundle mat according to claim 13, wherein the tip shape and the arc length of said fluffing teeth 41 are the same or different from each other.

16. A fluffer for the oriented bamboo bundle mat according to claim 13, wherein the cutting edges are arranged in said fluffing teeth (41).

17. A fluffer for the oriented bamboo bundle mat according to claim 13, wherein the height of said fluffing teeth 41 is 0.5 to 0.75 times the bamboo wall thickness of the semicircular bamboo tube.

18. A fluffer for the oriented bamboo bundle mat according to claim 13, wherein the length of the fluffing teeth is 1.1 to 3 times the longitudinal distance between the teeth.

19. A fluffer for the oriented bamboo bundle mat according to claim 13, wherein convex roller is used as said driving roller, the surface of the driving roller has uniform convex pocks.
